(19) United States
(12) Patent Application Publication
(10) Pub. No.: US 2003/0218106 A1
(43) Pub. Date: Nov. 27, 2003

(54) Folding stand

(76) Inventor: Juergen Pensel, Altstatten (CH)

Correspondence Address: George L. Snyder, Jr., Hodgson Russ LLP, Suite 2000, One M&T Plaza, Buffalo, NY, 14203-2391, US

(21) Appl. No.: 10/386,301

(22) Filed: Mar. 11, 2003

Related U.S. Application Data
(63) Continuation-in-part of application No. 09/927,755, filed on Aug. 10, 2001, now abandoned.

(30) Foreign Application Priority Data
Aug. 16, 2000 (DE) 200 14 108.2

(51) Int. Cl. F16L 3/00

(52) U.S. Cl. 248/121

(57) ABSTRACT

A stand for a surgical microscope or other optical instrument is improved by providing separation units for dividing support members of the stand into separable portions for compacting the stand into a storage state characterized by a lower center of gravity, a smaller storage volume and a fixed and protected arrangement. In one embodiment, the stand comprises an extension arm supported by a column or a container. A separation unit divides the column or container into upper and lower portions, while other separation units divide the extension arm in several portions. Each separation unit preferably includes a vibration-damping element.

### CROSS REFERENCE TO RELATED APPLICATIONS

This application claims benefit as a Continuation-in-Part of U.S. application Ser. No. 09/927,755, which claims priority of the German Utility Model application 200 14 108.2 filed Aug. 16, 2000 which is incorporated by reference herein.

### FIELD OF THE INVENTION

The invention concerns a stand for an optical viewing device, in particular for a surgical stereomicroscope.

### BACKGROUND OF THE INVENTION

Stands are used for many optical viewing devices (microscopes, telescopes, binoculars, video, theodolites, photography, etc.). A stand eliminates the need to hold the viewing device manually, and a jitter-free and stable image is created for the viewer.

The viewer nevertheless needs to have the capability to pivot and orient the viewing device in any desired direction so as always to have the most optimum possible view of the desired image field.

Stands should ideally possess the following properties, among others:

Stability;

Tipover resistance;

Flexibility; and

Pivotability.

In presently known stands, the properties required above are achieved by suitable selection of materials, e.g. by the use of composite materials, and by way of design features. These design-related measures are directed principally toward the stationary state of the stand. Transport of the stand, with or without a viewing unit, is not taken into consideration in this context.

In clinical applications, the following additional requirements result from the fact that the viewing units must be displaced and in some cases stored:

Tipover resistance during transport;

Small volume for transport and storage; and

Protection of the viewing unit during transport.

The existing systems, in particular stands in the field of surgical microscopes, are afflicted with disadvantages in terms of the following:

Center of gravity is much too high, resulting in little tipover resistance when transported;

The stand, or the stand including the viewing unit, is too bulky when packed;

Too little damage protection for the viewing unit;

Storage footprint too large; and

Transport volume too large.

### SUMMARY OF THE INVENTION

It is thus the object of the invention to find an improvement which eliminates the disadvantages indicated above and meets both the requirements of a standard stand and the special requirements of a stand for surgical microscopy, in particular as regards storage and transport.

This object is achieved by the use of a foldable stand which, by way of assembly separation units, either divides the various stand supports into shorter elements and/or makes the individual supports easily removable.

Bendable, foldable, or telescopable reduction units are used, for example, for the assembly separation units.

It is thereby possible, without impairing the stationary properties of the stand, to achieve for transport and storage, both with and without a viewing unit, the improvements listed below:

a) Lowering of the center of gravity during transport;

b) Reducing the transport volume;

c) Protecting the viewing unit, if the separation units are arranged and configured; and

d) Reducing the storage footprint.

A particular development of the invention consists in

a) combining said units with the conventionally known materials for vibration damping, or configuring the separation units themselves as vibration-damping elements; and

b) integrating into the separation units the necessary electrical and electro-optical (e.g. light-guiding) connections inside the stand.

### BRIEF DESCRIPTION OF THE DRAWINGS

The invention will be described below, in exemplary embodiments, with reference to the schematic drawings, in which:

FIG. 1 shows a symbolic configuration of the stand in the “folded” state, useable for transport, storage, parking and service;

FIG. 1a shows a detail of FIG. 1, namely the lower fixing unit of the assembly shown in FIG. 1;

FIG. 2 shows the stand in the “unfolded” ready-to-use-state;

FIG. 3a and FIG. 3b demonstrate possible arrangements of fixing latches instead of fixing units as shown in FIG. 1;

FIG. 4 shows another possible arrangement of opposite fixing claws;

FIGS. 4a, 4b and 4c are detailed views of a claw according to FIG. 4;

FIG. 5 shows an arrangement, where the “folded” stand is held in its position by magnets;

FIG. 6 shows schematically a solution with bur fasteners; and

FIG. 7 shows an in the half openable arrangement of a column or container.

### DETAILED DESCRIPTION OF THE INVENTION

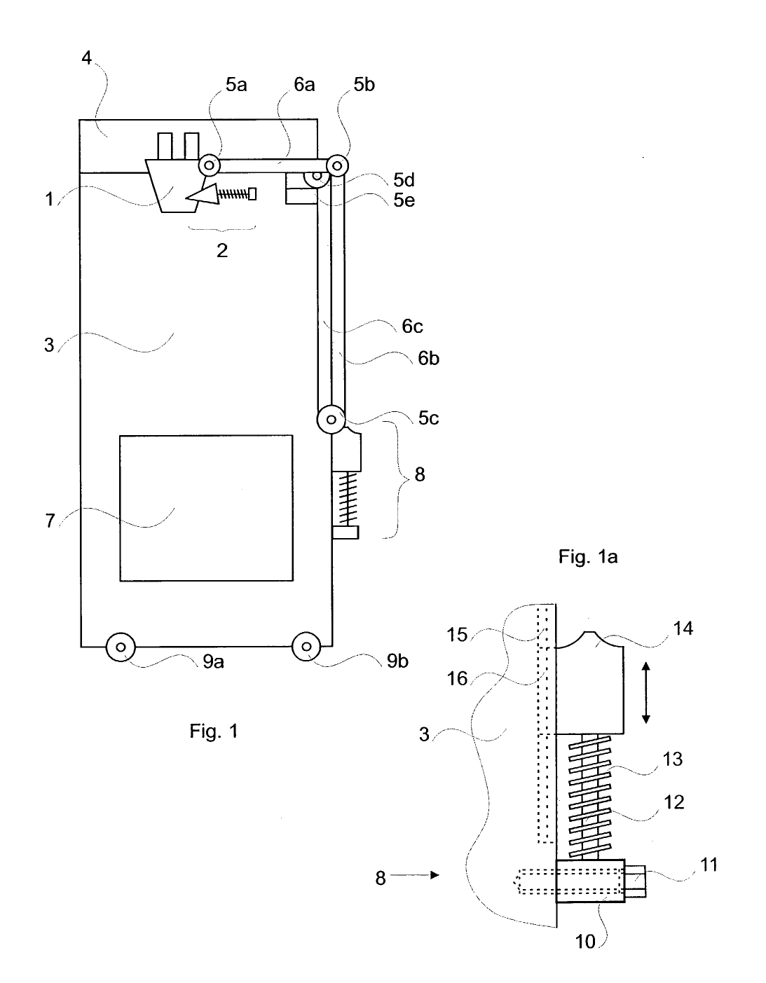

In FIG. 1 is schematically shown, how a preferred embodiment of the invention is arranged, when “folded” to the transport mode, which is also useable for storage, parking and service. A container or column 3 rolls on lockable castors 9a and 9b. The container or column 3 is also equipped with a storage compartment 7, where e.g. a removable lid 4 or other utensils can be stored. Extension arms 6a -c are mounted on the container or column 3 in that way, that a joint 5e allows a horizontal rotation when “unfolded”. Joints 5a-d connect the extension arms 6a-c and allow a perpendicular movement of a viewing unit 1, shown in this figure “locked” by a fixing unit 2 in a protecting recess 18. When the stand is in the shown transport mode, a second fixing 8 unit holds simultaneously the folded pair of extension arms 6b and 6c attached to the container or column 3.

FIG. 1a shows an arrangement of the fixing unit in detail: A fixing block 10 is mounted with one or several screws 11 on the container 3 and supports a pin 12. The pin 12 is surrounded by a spring 13 and allows by this a vertical movement of the snap bolt along a guide rail 15.

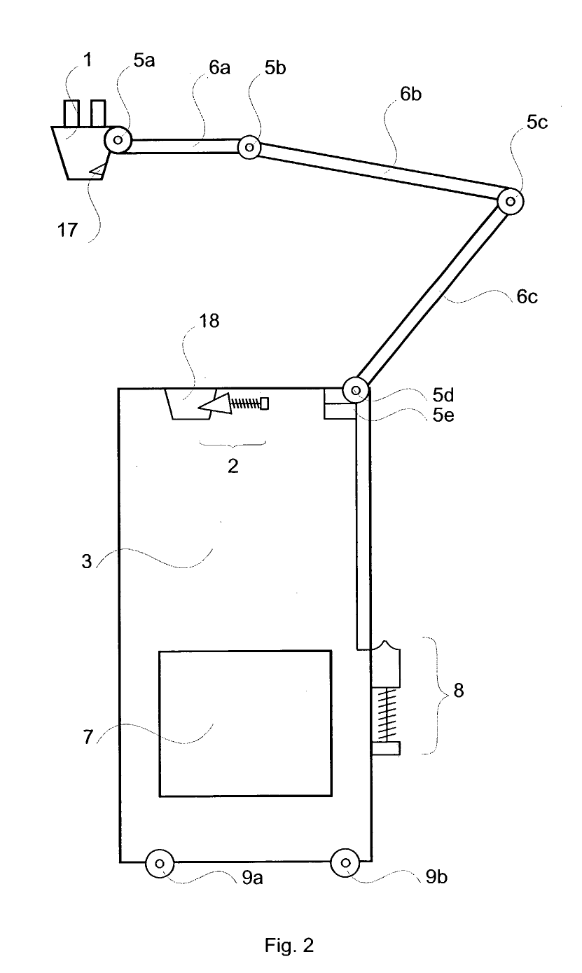

FIG. 2 shows schematically the “unfolded” mode, in which the stand and the microscope is ready-to-use. A recess 17 for the snap bolt of the fixing unit 2 is now visible in the body of the viewing unit 1. Furthermore, a protecting recess 18 in the container or column 3 is now visible, too.

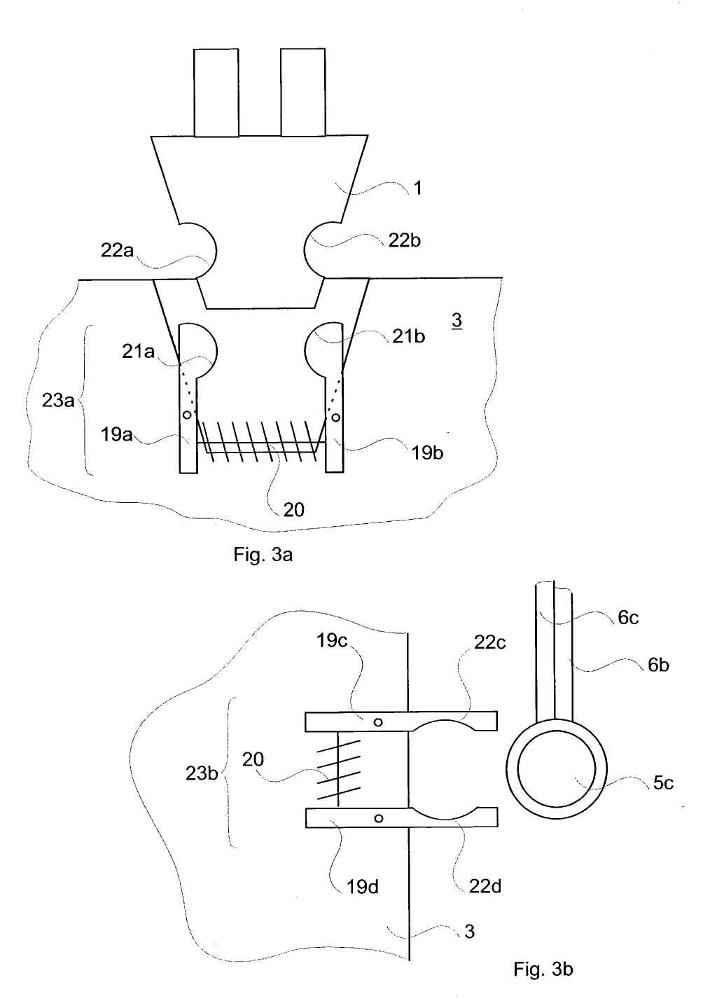

FIG. 3a shows as another possible arrangement instead of the fixing units 2 and 8 a fixing latch 23a, consisting of a pair of opposite jaws 19a and 19b, rotatably mounted on the container or column 3, but enforced by a compression spring 20. The jaws 19a and 19b are provided with keys 21a and 21b, and the viewing unit 1 with corresponding slots 22a and 22b. Thus it is possible to attach on or detach off the viewing unit 1 to the column or container 3.

FIG. 3b shows a fixing latch 23b for fixing the extension arm 6. Due to the same principle as shown in FIG. 3a, slots 22c and 22d correspond to the diameter of the joint 5c and provide a fixation.

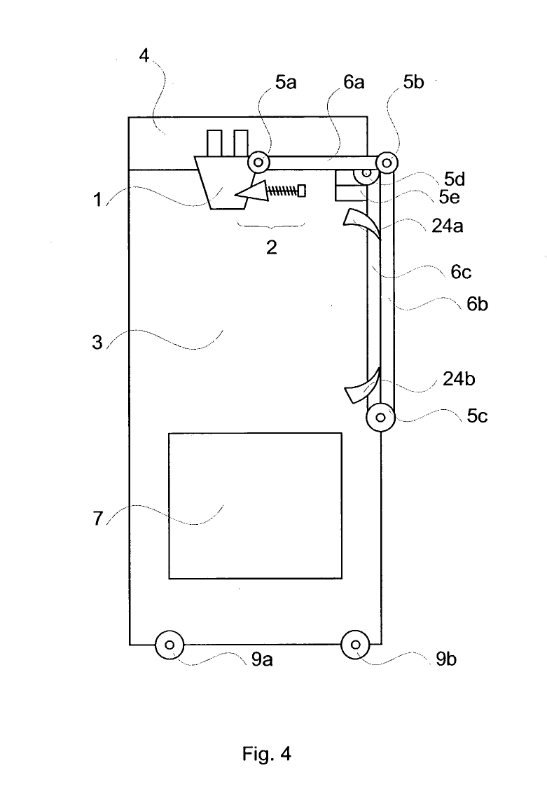

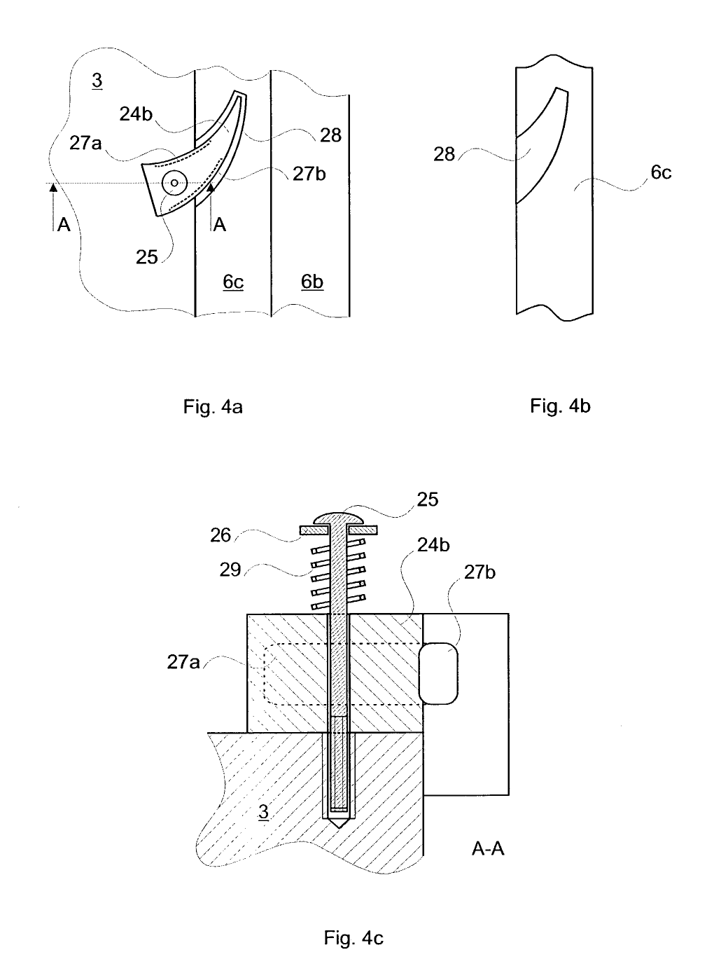

FIG. 4 shows another mode for fixing the folded extension arm 6. Two claws 24a and 24b are insertable in two corresponding recesses 28a and 28b of the portion 6c of the extension arm 6.

FIG. 4a shows in detail the claw 24b. In this view it can be seen, that the claw 24b is equipped with both sided grip hollows 27a and 27b, in order to grasp the claw and pull it—against the resistance of spring 29 (FIG. 4c)—into the recess 28 of the portion 6c of the extension arm 6 (FIG. 4b).

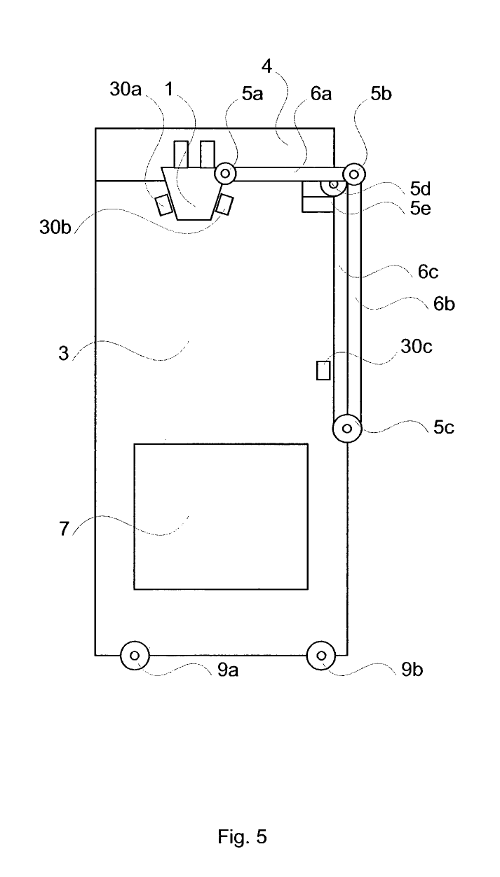

FIG. 5 points schematically out an assembly, where the fixation of the viewing unit 1 and the folded extension arm is provided by magnets 30a-c. In a preferred version of the invention the magnets 30a-c are controllable electro magnets. During the secured transport and storage mode of the stand a battery or an accumulator furnishes the necessary current.

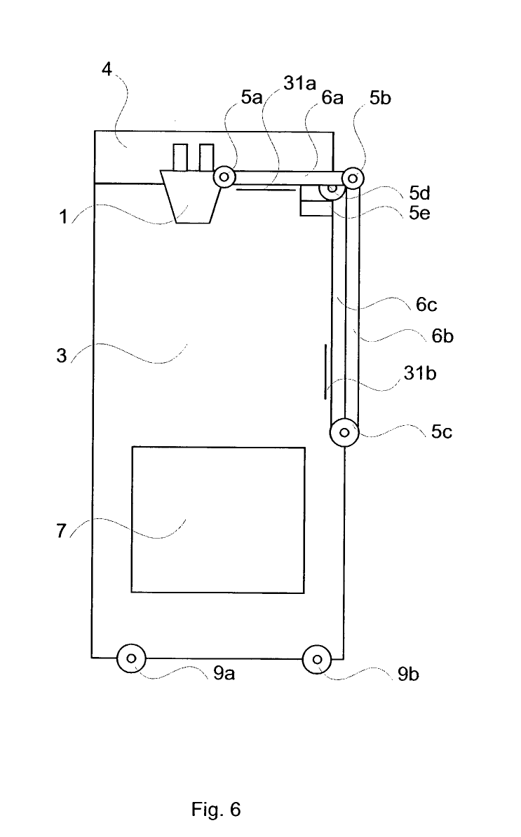

FIG. 6 indicates a mode for fixing the portions 6c and 6a of the extension arm 6 with bur fasteners 31a and 31b. For hygienic reasons the bur fastener is preferably placed on the portion 6a of the extension arm 6 and not on the viewing unit 1 itself.

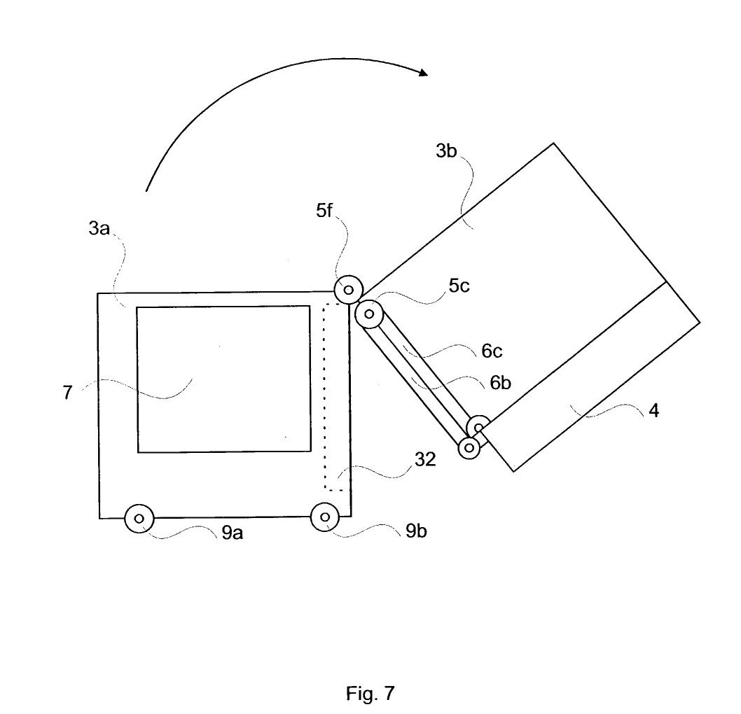

FIG. 7 shows how the column or container 3 can be divided along at least one joint 5f or a hinge 5f in two parts 3a and 3b, whereby the folded portions 6b and 6c of the extension arm 6 are hided in a protection recess 32 of the part 3a. Preferably the part 3a is heavier than the part 3b and the part 3b (respective the removable lid 4) is equipped with lockable castors, too.

### PARTS LIST

| | |
|---|---|
| 1 | Viewing unit or surgical microscope |
| 2 | Fixing unit |
| 3 | Container, column |
| 4 | Removable lid |
| 5a-d | Joint |
| 6 | Extension arm |
| 6a-c | Portions of extension arm 6 |
| 7 | Storage compartment |
| 8 | Fixing unit |
| 9a, b | Castor |
| 10 | Fixing block |
| 11 | Screw |
| 12 | Pin |
| 13 | Spring |
| 14 | Snap bolt |
| 15 | Guide rail |
| 16 | Sled |
| 17 | Recess for fixing unit 2 |
| 18 | Protecting recess for viewing unit 1 |
| 19a-d | Jaw |
| 20 | Compression spring |
| 21a, b | Key |
| 22a-d | Slot |
| 23a, b | Fixing latch |
| 24a, b | Claw |
| 25 | Square bolt |
| 26 | Disc |
| 27a, b | Grip hollow |
| 28a, b | Recess for claw 24 |
| 29 | Spring |
| 30a-c | Magnet |
| 31a, b | Bur fastener |
| 32 | Recess for folded portions 6b and 6c |

What is claimed is:

1. In a stand for holding a surgical microscope (1), said stand having a column or container (3) extending along a vertical axis and an extension arm (6) connected to said column or container (3), the improvement comprising:
separation units (5a-d) dividing said extension arm (6) into portions (6a-c) and providing respective folding connections between each of said portions (6a-c) of said extension arm (6), one of said portions (6a) being adapted for mounting said surgical microscope (1) thereon and another one of said portions (6c) being pivotally mounted on said column or container (3) allowing a rotation relative to said column or container (3) about a horizontal axis;
wherein said separation units (5a-d) enable said stand to be adjusted between a normal usage state and a storage state, said stand having a lower center of gravity and a smaller storage volume in said storage state than in said normal usage state, and said surgical microscope (1) and said portions (6a-c) of said extension arm (6) are arranged in a protected and fixed mode when said stand is in said storage state.

2. The improvement of claim 1, wherein the fixation force of said surgical microscope (1) respective said portions (6a-c) of said extension arm (6) is provided by at least one spring-reinforced fixing unit (2, 8, 23a, 23b, 24a, 24b).

3. The improvement of claim 1, wherein the fixation force of said surgical microscope (1) respective said portions (6a-c) of said extension arm (6) is provided by magnets (30a-c).

4. The improvement of claim 3, wherein said magnets (30a-c) are electro magnets.

5. The improvement of claim 1, wherein the fixation of said surgical microscope (1) respective said portions (6a-c) of said extension arm (6) is provided by bur fasteners (31a, 31b).

6. The improvement of claim 1, wherein a further separation unit (5f) provides a folding connection between an upper (3b) and a lower (3a) portion of said column or container (3).

7. The improvement of claim 1, wherein said separation units (5a-f) are joints.

8. The improvement of claim 7, wherein said separation units (5a-f) comprise a fixation.

9. The improvement of claim 1, wherein said separation units (5a-f) comprise opposed mounting plates for detaching and exchanging the connected portions (6a-c), respectively (3a and 3b).

10. The improvement of claim 1, wherein said portions (6a-c) of said extension arm (6) are telescopically extendable or shortenable.

11. The improvement of claim 1, wherein said separation units (5a-f) comprise a vibration-damping element.

12. The improvement of claim 1, wherein an electrical connection is integrated into said separation units (5a-f).

13. The improvement of claim 1, wherein an electro-optical connection is integrated into said separation units (5a-f).

14. The improvement of claim 1, wherein a light-guiding connection is integrated into said separation units (5a-f).
